(19) United States
(12) Patent Application Publication
(10) Pub. No.: US 2010/0069266 A1
(43) Pub. Date: Mar. 18, 2010

(54) PROCESS FOR THE ENZYMATIC REMOVAL OF FILTER-CAKES PRODUCED BY WATER-BASED DRILLING AND COMPLETION FLUIDS

(75) Inventors: Ezio Battistel, Cameriano (IT); Daniele Bianchi, Arese (IT); Sandra Cobianco, San Donato Milanese (IT); Marco Fornaroli, Milan (IT)

Correspondence Address: OBLON, SPIVAK, MCCLELLAND MAIER & NEUSTADT, L.L.P., 1940 DUKE STREET, ALEXANDRIA, VA, 22314, US

(73) Assignee: ENI S.P.A., Rome (IT)

(21) Appl. No.: 12/513,042

(22) PCT Filed: Oct. 29, 2007
(86) PCT No.: PCT/EP2007/009448

§ 371 Date: Jun. 3, 2009

(30) Foreign Application Priority Data
Nov. 3, 2006 (IT) MI2006A002105

(51) Int. Cl. C09K 8/02

(52) U.S. Cl. 507/101

(57) ABSTRACT

The invention relates to a process for the solubilization of material containing scleroglucan and/or xanthan gum which comprises putting the above material in contact with an aqueous solution comprising an enzyme selected from a cellulase from Trichoderma reesei and/or a glucosidase from Aspergillus Niger.

The present invention relates to a process for the removal of filter-cakes which are formed in oil wells during drilling operations.

More specifically, the invention relates to a process for the removal of filter-cakes by treatment with aqueous solutions of particular enzymatic systems capable of operating a medium-low temperatures and pressures.

Increasing attention has been paid over the last few years to the development of new drilling and completion fluids capable of limiting damage to the production formation (rocks containing gas/petroleum) induced by their use. Most drilling fluids are formulated so as to deposit a relatively impermeable layer or film (filter-cake) on the walls of the drilling hole to prevent loss of fluid in the formation (leak off).

The progressive deposition of a layer of material (filter-cake) consisting of a polymer and particles in suspension prevents the excessive invasion of the rock on the part of the liquid.

Filter-cake has various important functions, in addition to its main function of limiting the leakage of drilling fluid, such as for example, consolidating the formation, preventing blockage due to cuttings, etc. At the end of the drilling phase, on the other hand, during the well completion operations, the filter cake must be removed (clean-up) to allow the start-up of the oil or gas production.

A typical water-based drilling fluid contains, in addition to possible additives, two polymeric components having different specific functions.

One of the polymeric components consists of starch (maize, potato) normally chemically modified (hydroxypropyl starch, carboxymethyl starch, etc.) whose function is to reduce fluid leakage in the rock by reducing the pore permeability.

Starch is not particularly soluble in aqueous solutions below 50° C. and is present in the drilling fluid in the form of finely dispersed granular particles (typically with a diameter of 10-20 μm).

The other polymeric component is a natural polysaccharide, normally xanthan gum or scleroglucan whose main function is to increase the viscosity of the fluid to suspend the cuttings produced by the drilling.

Both xanthan gum and scleroglucan are high molecular weight polymers (even several million Dalton) capable of giving the filter-cake consistency, elasticity and solidity properties. They are also capable of increasing the viscosity even when they are present in low concentrations (0.1-0.5% by weight), swelling as a result of hydration and forming a gel. The gelifying capacity of the polymers (more or less thick gel) depends on its concentration and temperature.

At the end of the oil-well drilling operations, in order to re-establish the oil or gas flow from the formation and start the well production phase, the filter-cake must be completely and homogeneously removed.

Various chemical substances (breakers) can be used for the removal of the filter-cake, capable of removing or degrading at least one of the above-mentioned polymers.

The most commonly used are hydrochloric acid (10-15%), hydrofluoric acid (or mixtures of the two acids), other weaker organic acids (for example, acetic acid), oxidizing agents (for example persulphates or hypochlorite) (U.S. Pat. No. 5,607,905 and U.S. Pat. No. 5,247,995.

Many of these chemical agents are highly reactive and as a result of their high reactivity they can cause undesirable side-effects such as, for example, excessive stimulation of the rock formation due to the excessive dissolution of minerals. This can lead to a temporary increase in the permeability followed by progressive deterioration due to the precipitation of the components removed. It may also happen that preferential channels are formed with a high permeability which are the only ones capable of producing, whereas all the remaining part of the filter-cake remains unproductive.

In order to overcome these disadvantages and find equally effective or improved solutions, capable of also operating at medium-low temperatures and pressures, systems have been studied which are exclusively based on the use of enzymes.

Enzymes are potentially excellent candidates for clean-up applications in the extraction phase of oil products as they can degrade the polymeric components of the filter-cake (natural and modified polysaccharides) in a specific and controlled manner thus re-establishing the permeability of the rock.

This capacity is correlated to the particular properties of enzymes which are: a) the high specificity, which allows the activity to be accurately controlled with respect to the polymeric substrate; b) the catalytic efficiency, which allows a high reaction rate per mole of reacted product to be obtained, under optimum conditions; c) activity under bland conditions. Their use as breakers has therefore allowed well completion operations to be optimized and reduce damage caused by fracturing during drilling.

It should be noted that, unlike acids and other chemical oxidants, enzymes do not interact with the formation rock and with the metals present, thus making undesirable secondary reactions impossible.

The use of enzymes capable of only hydrolyzing the starch (amylase) present in the filter-cake, however, can lead to a reduction in the rock permeability due to the penetration of viscosizing agents soluble in the pores of the rock itself (EP 1103697). By proceeding before the degradation of the soluble polymers used as viscosizing agents, however, there are no negative effects on the porosity of the rock. In this case, in fact, the starch remaining after destroying the integrity of the filter-cake does not penetrate the rock pores as it is insoluble and is easily removed by washing.

U.S. Pat. No. 5,247,995 describes the use of hydrolytic enzymes for the removal of filter-cake. Although the patent mentions the group of glucosidase hydrolytic enzymes and various other groups, it does not face the problem of the removal of filter-cake comprising viscosizing agents such as xanthan gum and scleroglucan.

U.S. Pat. No. 5,165,477 describes a method which is based on the use of enzymes for the removal of residues of drilling fluid remaining on the well bottom before beginning the completion phase.

The drilling fluid comprises viscosizing agents consisting of various kinds of polymeric compounds including xanthans (xanthan gum) and glucanes. The removal of the residues can be effected by treatment with different groups of hydrolytic enzymes. The patent however does not face the problem of the removal of filter-cake.

U.S. Pat. No. 6,818,594 describes the use of enzymes for the degradation of substrates used in upstream oil. The deactivated enzymes are encapsulated in particular polymeric materials and activated by changing the conditions of the aqueous suspension medium. In particular, the patent describes the use of encapsulated enzymes for the degradation of biopolymers normally present in filter-cakes. Xanthans and glucans (scleroglucan included) are mentioned as examples of biopolymers, whereas glucosidase and cellulase (ULTRA L, Novo Nordisk) are mentioned as being among the enzymes which can be used for their degradation.

An enhanced process for the degradation of scleroglucan and/or xanthan gum has now been found, based on the use of specific enzymes, such as cellulase obtained from Trichoderma reesei and/or the glucosidase obtained from Aspergillus niger.

These enzymes have surprisingly proved to have the capacity of degrading scieroglucan and/or xanthan gum with a higher efficacy than that demonstrated by the enzymes of the known art.

In accordance with this, the present invention relates to a process for the solubilization of material containing scieroglucan and/or xanthan gum, which comprises putting the above material in contact with an aqueous solution comprising an enzyme selected from a cellulase from Trichoderma reesei and/or a glucosidase from Aspergillus niger.

The enzymes of the invention have proved to be particularly suitable for the removal of filter-cakes containing xanthan gum and scieroglucan in upstream oil operations.

A further object of the invention relates to the use of cellulase from Trichoderma reesei and the use of glucosidase from Aspergillus niger for the degradation of scleroglucan and/or xanthan gum.

The enzymes of the invention are commercially available (Novozymes, Denmark) and can be conveniently used in upstream oil operations for the solubilization of filter-cakes containing scleroglucan and/or xanthan gum.

The degradation of the material containing the viscosizing agents scleroglucan and xanthan gum is effected with cellulase or glucosidase under static temperatures conditions ranging from 10 to 60° C. and preferably 30 to 50° C.

The material is suspended in water so as to obtain a concentration of viscosizing agents ranging from 0.01 to 5% by weight and preferably within the range of 0.1 to 0.6% by weight.

The suspension can be treated with a homogenizer and the insoluble components can be separated through conventional solid-liquid separation processes.

A solution of cellulase and/or glucosidase enzyme having a concentration of proteins ranging from 0.1 to 20 mg/ml and preferably from 1 to 5 mg/ml, is then added to the supernatant.

The pH of the solution ranges from pH 3 to pH 6, and preferably from pH 4.5 to pH 5.5.

The supernatant/enzyme solution ratio generally ranges from 1 to 10, and preferably from 2 to 4.

The enzymatic hydrolysis activity is followed by measuring the viscosity and determining the reducing sugars released.

It can also be followed by Gel Permeation Chromatography which determines the molecular weight variation of the polymer.

The degradation tests of the filter-cake can be effected in a high pressure, high temperature cell (filter-press, HTHP cell), using drilling fluids comprising starches, viscosizing agents, products for the reduction of the filtrate and soluble salts.

Starches which can be conveniently used are Dualflo, N-Drill HT, Flotrol, (commercialized by Halliburton) whereas xanthan gum and scleroglucan can be used as viscosizing agents.

The products for the reduction of the filtrate are insoluble in water and are used in the form of fine particulate with a controlled particle-size.

Calcium carbonate or bentonite is generally used, at a concentration of up to 15% by weight.

KCl can be used as soluble salt at a concentration ranging from 1 to 5% by weight (Table 2).

The filter-cake obtained consists of the same products present in the drilling fluids.

In practice, the formation of the filter-cake takes place on a permeable porous ceramic filter (10 Darcy) following the passage of the drilling fluid, inside the pressurized cylindrical cell (7 bar). The formation of the filter-cake causes the stoppage of the flow measured at the outlet of the porous filter. The substitution of the drilling fluid with a diluted aqueous solution containing the enzyme allows the flow to be re-established following the progressive degradation of the filter-cake.

The degradation test of the filter-cake which simulates the operative conditions at the well bottom was effected by studying the permeability of samples of Berea sandstone rock confined in an apparatus capable of passing pressurized fluids through the sample rock at constant temperatures (Permeability study in a porous medium). The apparatus has a cell (Hassler cell) in which the rock sample (cylindrical, 10×5 cm) is confined by hydrostatic pressure. The flow through the sample is regulated by a constant pressure pump. The measurement of the pressure gradient at the inlet and outlet of the sample allows the permeability of the medium to be calculated.

The considerable advantage of the process of the present invention consists in the fact that it is also effective at relatively low temperatures, i.e. from 10 to 60° C.

Furthermore, as demonstrated in the experimental part, the process of the present invention allows the initial permeability values to be re-established after degradation of the filter-cake obtained by means of the selective activity of the enzymes on the polymer components used as viscosizing agents.

The following examples are provided for a better understanding of the present invention.

### EXAMPLE 1

Degradation of Scleroglucan With Cellulase from Trichoderma Reesei—Viscosity and Enzymatic Activity

The degradation test was carried out using a solution of scleroglucan (Degussa) 0.2% by weight in water. The suspension was treated with a Silverson homogenizer (2,300 rpm for 60 min) and centrifuged at 18,000 rpm for 30 min. 20 ml of a solution of cellulase enzyme (Novozymes, Denmark) dialyzed with an ammonium acetate buffer 50 mM, pH 5, having a concentration of 3.2 mg of proteins/ml (Bradford method) were added to 110 ml of the supernatant. The resulting solution was maintained under static conditions at a temperature of 40° C. The viscosity was measured in relation to the time with a FANN 35 SA viscometer. Table 1 indicates the viscosity data in relation to the time obtained at a shear rate of 10 sec−1.

The enzymatic hydrolysis activity not only causes the progressive decrease in the viscosity but also the contemporary release of reducing sugars. The titration of the sugars was obtained by means of the Nelson-Somogyi method which consists in reacting an aliquot of the sample (0.250 ml) with the Nelson-Somogyi reagent (Methods in Enzymology, 1957, III, 73). The reaction causes the formation of a coloured complex characterized by a maximum absorption at 520 nm. It is possible to calculate the quantity of equivalent glucose released by means of a suitable calibration curve with solutions having a known titer of glucose. This quantity in relation to the time, expressing the enzymatic activity, is indicated in Table 1.

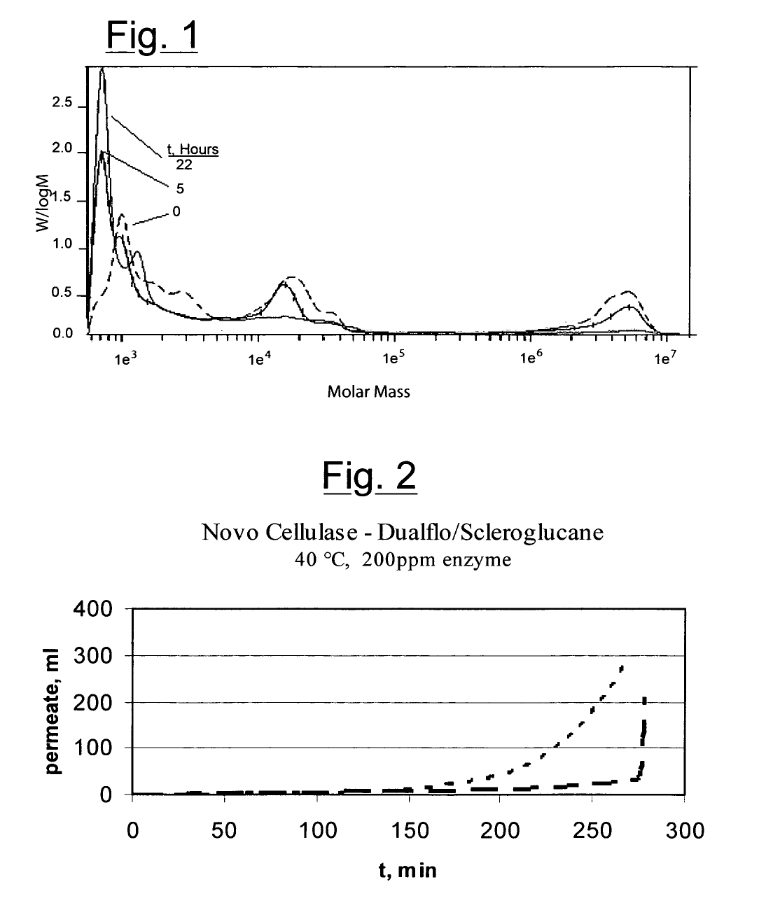

Following the hydrolysis activity of the enzyme, the molecular weight of the polymer progressively decreases. An analysis of the molecular weigh distribution was effected by means of Gel Permeation Chromatography (GPC) with a Hewlett Packard instrument capable of analyzing molecular weight distributions ranging from 1,000 to 50 million Dalton. The data relating to the viscosity and hydrolytic activity of the enzyme (titration sugars released, equivalent μmoles of glucose) in relation to the time are indicated in FIG. 1.

As can be observed, the viscosity of the solution is practically reduced to zero. The molecular weight of the non-treated polymer is about 1.5 million. The molecular weight distribution after the enzymatic treatment shows that most of the polymeric fragments have a molecular weight lower than 5,000 Dalton.

### EXAMPLE 2

### Degradation of Scleroglucan With Cellulase From Trichoderma Reesei—Removal of the Filter-Cake With a Filter-Press (HTHP Cell).

Degradation tests on the filter-cake were effected with a high pressure and high temperature cell (filter-press, HTHP cell) using drilling fluids with different starches and viscosizing agents. The composition of the drilling fluids used is indicated in Table 2. The filter-cake was deposited on 10 Darcy ceramic disks, 2.5×0.25 inches using 250-300 ml of drilling fluid under a pressure of 300 psi. The fluid was stirred in the filter-press for 30 minutes at 500 rpm. The volume of the permeate was followed in relation to the time by means of weight registration. After washing the filter-cake several times with brine (3% KCl), 300-400 ml of brine were added, to which 25 ml of buffer were added for the pH control (acetate 50 mM pH 5, tris 50 mM pH 7.2) and 5 ml of the solution containing the enzyme. The final concentration of the enzyme was 20-30 mg/L. The volume of the permeate through the filter-cake was registered in relation to the time after applying a pressure of 100 psi (7 atm) without stirring.

FIG. 2 indicates the flow recovery curve after degradation of the filter-cake in the presence of cellulase. As can be observed, the enzyme is able to degrade the filter-cake, causing a sudden increase in the flow through the porous filter. The mud used contained Scleroglucan/Dualflo. The two curves were obtained with filter-cakes prepared with various types of Ca carbonate. In one case (dashed curve) a generic carbonate was used with a very wide particle distribution (non-controlled particle-size). In the other case, (dotted curve) two carbonates with a controlled particle-size were used.

### EXAMPLE 3

### Degradation of Scleroglucan With Cellulase From Trichoderma Reesei—Removal of the Filter-Cake on a Porous Medium.

Permeability tests were carried out using Berea cores (10 cm, diameter 5 cm) confined by hydrostatic pressure in an apparatus (Hassler cell) capable of allowing pressurized fluids to permeate through the core. The composition of the mud used for depositing the filter-cake on the free surface of the core is indicated in Table 2 (mud based on Scleroglucan-starch N-Drill HT). The permeability recovery tests, K, after degradation treatment of the filter-cake were effected at 40° C. The results are indicated in Table 3.

The permeability was measured by pumping brine (KCl, 3% w/w). The formation of the filter-cake caused an almost complete reduction of the flow. The cellulase solution (2 mg/ml) was put in contact with the filter-cake under a pressure of 14 bar. After 20 hours of shut-in (under flow-stop conditions), the brine was pumped in counterflow (entering from the opposite side with respect to the filter-cake). As can be observed in Table 3, a return of the permeability was noticed (74.7 mD) equal to 89% of the initial value, indicating that the activity of the enzyme had allowed degradation of the scleroglucan contained in the filter-cake which had been almost completely removed allowing the liquid to flow in counter flow.

### EXAMPLE 4

Degradation of Starch With Amylase from Bacillus Licheniformis—Removal of the Filter-Cake on a Porous Medium

The experiment on a porous medium described in Example 3 was repeated. Instead of degrading scleroglucan (viscosizing polymer) with cellulase, the starch (N-Drill Ht starch, see Table 1) present in the filter-cake was degraded with amylase from Bacillus licheniformis (Sigma) which, from the activity tests, showed a high hydrolytic capacity with respect to said starch. The permeability recovery tests, K, after degradation treatment of the filter-cake, were carried out at 40° C. The results are indicated in Table 4.

The amylase solution (2.1 mg/ml, pH 5) was put in contact with the filter-cake under a pressure of 14 bar. After 20 hours of shut-in (under flow-stop conditions), the brine was pumped in counterflow (entering from the opposite side with respect to the filter-cake). As can be observed in Table 4, a return of the permeability was noticed (48.7 mD) equal to 50% of the initial value, slightly higher than that obtained (42.1 mD) by pumping brine only in counterflow (Table 4). This result indicates that the hydrolysis of the starch on the part of the enzyme with the consequent degradation of the filter-cake allowed the scleroglucan, soluble and intact, to penetrate the rock pores only causing a modest permeability recovery.

### EXAMPLE 5

Degradation of Xanthan Gum With Cellulase from Trichoderma Reesei—Viscosity and Enzymatic Activity.

The experiment of Example 1 was repeated, using xanthan gum as substrate instead of scleroglucan. A solution of xanthan gum (Degussa) in water (0.2% by weight) was treated with a Silverson homogenizer (2,300 rpm for 60 minutes). 15 ml of a solution of Cellulase enzyme (Novozymes, Denmark), dialyzed with an ammonium acetate buffer 50 mM, pH 5, having a concentration of 3.2 mg of proteins/ml (Bradford method) were added to 118 ml of the solution. The viscosity data of the mixture and hydrolytic activity of the enzyme (titration sugars released, equivalent μmoles of glucose), measured in relation to the time at 40° C., are indicated in Table 5.

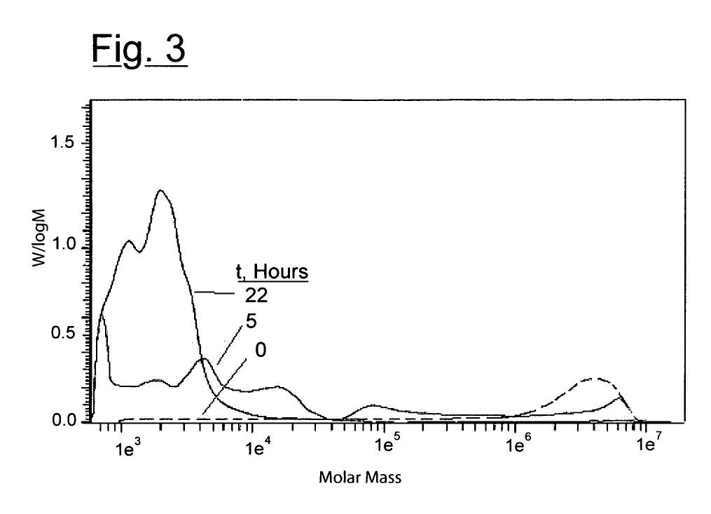

An analysis of the molecular weight distribution in relation to the degradation time followed by means of Gel Permeation Chromatography is indicated in FIG. 3.

As can be observed, the viscosity drops rapidly to minimum values, whereas the molecular weight distribution indicates the complete degradation of the polymer (initial average molecular weight 1.5-1.8 million) into fragments having a molecular weight lower than 10,000 Dalton.

### EXAMPLE 6

Degradation of Scleroglucan With Glucosidase from Aspergillus Niger—Viscosity and Enzymatic Activity.

The experiment was carried out under the same conditions described in Example 1. 6 ml of a solution 40 mg/ml of glucosidase from Aspergillus niger (Sigma-Aldrich, Italia) in an ammonium acetate buffer 50 mM pH 5, were added to 140 ml of a suspension of scleroglucan 0.2% by weight prepared as described in Example 1. The degradation took place under static conditions at 40° C. The data relating to the viscosity and enzymatic activity (equivalent μmoles of glucose) are indicated in Table 6.

### EXAMPLE 7

### Degradation of Xanthan Gum With Glucosidase From Aspergillus Niger—Viscosity.

The experiment was carried out under the same conditions described in Example 5. 6 ml of a solution 40 mg/ml of glucosidase from Aspergillus niger (Sigma-Aldrich, Italy) in an ammonium acetate buffer 50 mM pH 5, were added to 120 ml of a suspension of xanthan gum 0.2% by weight prepared as described in Example 2. The degradation took place under static conditions at 40° C. The viscosity data are indicated in Table 7.

### EXAMPLE 8

### Comparative

### Activity of a Generic Glucosidase on Xanthan Gum and Scleroglucan.

The enzymatic activity was determined by titration of the reducing sugars freed by the action of the enzyme. The quantitative titration was obtained by means of the Nelson-Somogyi method. The method consists in reacting an aliquot of the sample (0.250 ml) with the Nelson-Somogyi reagent (Methods in Enzymology, 1957, III, 73).

The enzyme was reacted under standard conditions with a water solution of xanthan gum (Degussa) 0.2% w/w or scleroglucan (Degussa) 0.2% w/w, treated with a Silverson homogenizer (2,300 rpm for 60 minutes).

Definition of Unit (U): 1 Unit is the amount of enzyme which releases 1 micromole of reducing sugar per hour, at a certain temperature and pH. The specific activity is given by the units per milligram of enzyme (U/mg).

The quantitative determination of the enzyme in solution was obtained by means of the protein titration method proposed by Bradford (Bradford, M. Anal. Biochem., 1976, 72, 248). 0.1 ml of a glucosidase solution from Saccharomyces cerevisiae, dissolved in a sodium phosphate buffer 100 mM, pH 6.8, at a concentration of 3 mg/ml (Bradford method) and 0.1 ml of the same buffer, were added to 2 ml of the aqueous substrate solution (xanthan gum or scleroglucan). The resulting solution was maintained under light stirring conditions, at a temperature of 40° C. for 3 hours.

The glucosidase activity was 0.01 U/mg and 0.005 U/mg for the xanthan gum and scleroglucan, respectively. The activity is extremely low, near the sensitivity limit of the method.

### EXAMPLE 9

Activity of Glucosidase from Aspergillus Niger on Xanthan Gum and Scleroglucan.

The enzymatic activity test is carried out according to the conditions described in example 8.

0.1 ml of a solution of glucosidase from Aspergillus niger, dissolved in a sodium acetate buffer 100 mM, pH 5, at a concentration of 2.5 mg/ml (Bradford method) and 0.1 ml of the same buffer, were added to 2 ml of an aqueous solution of xanthan gum or scleroglucan. The resulting solution was maintained under light stirring conditions, at a temperature of 40° C. for 3 hours.

The glucosidase activity was 0.40 U/mg and 0.70 U/mg for the xanthan gum and scleroglucan, respectively.

### EXAMPLE 10

### Comparative

Activity of α-Glucanase (ULTRA L, Novo Nordisk; U.S. Pat. No. 6,818,594) (Amylase) on Xanthan Gum and Scleroglucan.

The enzymatic activity test is carried out according to the conditions described in example 8.

0.1 ml of an α-glucanase (ULTRA L, amylase) solution, in an ammonium acetate buffer 100 mM, CaCl₂ 1 mM, pH 5, or in a tris buffer 100 mM, CaCl₂ 1 mM, pH 7.2 (concentration of 2.8 mg/ml, Bradford method) and 0.1 ml of the corresponding buffer, were added to 2 ml of an aqueous solution of xanthan gum or scleroglucan. The resulting solution was maintained under light stirring conditions, at a temperature of 40° C. for 3 hours.

The activity of α-glucanase was 0.006 U/mg and 0.009 U/mg for xanthan gum and scleroglucan, at pH 5 and 0.007 U/mg and 0.008 U/mg at pH 7.2, respectively.

The activity is extremely low, near the sensitivity limit of the method.

### EXAMPLE 11

### Comparative

### Activity of a Generic Cellulase on Xanthan Gum and Scleroglucan.

The enzymatic activity test is carried out according to the conditions described in example 8.

0.1 ml of a cellulase solution from Aspergillus niger in ammonium acetate 100 mM, pH 5, (concentration of 3 mg/ml, determined with the Bradford method) and 0.1 ml of the same buffer, were added to 2 ml of an aqueous solution of xanthan gum or scleroglucan. The resulting solution was maintained under light stirring conditions, at a temperature of 40° C. for 3 hours.

The cellulase activity was 0.010 U/mg and 0.030 U/mg for xanthan gum and scleroglucan, respectively.

The activity was extremely low.

### EXAMPLE 12

### Activity of Cellulase From Trichoderma Reesei on Xanthan Gum and Scleroglucan.

The enzymatic activity test is carried out according to the conditions described in example 8.

0.1 ml of a cellulase solution from Trichoderma reesei in an ammonium acetate buffer 100 mM, pH 5, (concentration of 2.4 mg/ml, Bradford method) and 0.1 ml of the same buffer, were added to 2 ml of an aqueous solution of xanthan gum or scleroglucan. The resulting solution was maintained under light stirring conditions, at a temperature of 40° C. for 3 hours.

The cellulase activity was 0.50 U/mg and 0.72 U/mg for xanthan gum and scleroglucan, respectively.

Table 8 indicates the data relating to the specific activity of the enzymes tested on xanthan and on scleroglucan (examples 8-12).

TABLE 1

| | Viscosity (shear rate, 10 sec⁻¹, | Equivalent μmoles of |
|---|---|---|
| Time, hours | cp | glucose |
| 0 | 92 | 0.000 |
| 1 | 70 | 0.016 |
| 1.5 | 62 | 0.034 |
| 4 | 48 | 0.110 |
| 22 | 9 | 0.475 |

TABLE 2
Drilling fluid composition. Quantity of water in g/L

| Brine | Viscosizing agent | starch | Filtrate reducer | biocide |
|---|---|---|---|---|
| KCl | scleroglucane/ | Dualflo/ | CaCO₃ | Glutaraldehyde |
| | xanthan gum | N-Drill HT | | (1%) |
| 30 | 5 | 20 | 100 | 1 ml |

TABLE 3
Permeability, K (mD) brine (KCl 3%), 40° C.

| Direction | Initial | with filter-cake | after cellulase |
|---|---|---|---|
| Flow | 90.0 | 0.01 | — |
| Counterflow | 83.7 | 42.0 | 74.7 |

TABLE 4
Permeability, K (mD) brine (KCl 3%), 40° C.

| Direction | Initial | with filter-cake | after cellulase |
|---|---|---|---|
| Flow | 111.0 | 0.01 | — |
| Counterflow | 95.5 | 42.1 | 48.7 |

TABLE 5

| | Viscosity (shear rate, 10 sec⁻¹, | Equivalent μmoles of |
|---|---|---|
| Time, hours | cp | glucose |
| 0 | 100 | 0.000 |
| 0.04 | 67 | 0.001 |
| 0.1 | 5 | 0.002 |
| 0.4 | 9.6 | 0.005 |
| 1.1 | 9 | 0.011 |
| 2.0 | 11 | 0.020 |
| 4.0 | 13 | 0.027 |
| 20.0 | 9 | 0.120 |

TABLE 6

| | Viscosity (shear rate, 10 sec⁻¹, | Equivalent μmoles of |
|---|---|---|
| Time, hours | cp | glucose |
| 0 | 100 | 0.00 |
| 0.08 | 91 | 0.05 |
| 0.5 | 86 | 0.48 |
| 1 | 72 | 0.69 |
| 2 | 62 | 1.04 |
| 5 | 28 | 1.75 |

TABLE 7

| | Viscosity (shear rate, 10 sec⁻¹, |
|---|---|
| Time, hours | cp |
| 0 | 106 |
| 1 | 86 |
| 2 | 76 |
| 24 | 50 |

TABLE 8

| | | Specific activity | Specific activity |
|---|---|---|---|
| | | (U/mg) on xanthan | (U/mg) on |
| Ex. | Enzyme | gum | scleroglucan |
| 8 | glucosidase | 0.010 | 0.005 |
| 9 | A. niger glucosidase | 0.40 | 0.70 |
| 10 | α-glucanase (ULTRA L, | 0.006 | 0.009 |
| | Novo Nordisk) pH 5 | | |
| 10 | α-glucanase (ULTRA L, | 0.007 | 0.008 |
| | Novo Nordisk) pH 7.2 | | |
| 11 | cellulase | 0.010 | 0.030 |
| 12 | cellulase from T. reesei | 0.50 | 0.72 |

1. A process for the solubilization of material containing scleroglucan and/or xanthan gum, which comprises:
contacting said scleroglucan and/or xanthan gum material with an aqueous solution comprising an enzyme selected from the group consisting of a cellulase from Trichoderma reesei, a glucosidase from Aspergillus Niger and combinations thereof.

2. The process according to claim 1, wherein the material containing scleroglucan and/or xanthan gum consists of a filter-cake obtained in upstream oil operations.

3. The process according to claim 1, wherein the material is contacted with the aqueous solution of the enzyme at a temperature ranging from 10 to 60° C.

4. The process according to claim 3, wherein the material is contacted with the aqueous solution of the enzyme at a temperature ranging from 30 to 50° C.

5. The process according to claim 1, wherein the material is suspended in water so as to obtain a viscosizing agent having a concentration ranging from 0.01 to 5% by weight.

6. The process according to claim 5, wherein the concentration of viscosizing agent ranges from 0.1 to 0.6% by weight.

7. The process according to claim 1, wherein the concentration of the enzyme in the aqueous solution ranges from 0.1 to 20 mg/ml.

8. The process according to claim 7, wherein the concentration of the enzyme ranges from 1 to 5 mg/ml.

9. The process according to claim 5, wherein the aqueous suspension of the material is mixed with that of the enzyme in a ratio ranging from 1 to 10.

10. The process according to claim 9, wherein the ratio between the aqueous suspension of the material and that of the enzyme ranges from 2 to 4.

11. The process according to claim 1, wherein the aqueous suspension of the enzyme has a pH ranging from 3.0 to 6.0.

12. The process according to claim 11, wherein the aqueous suspension of the enzyme has a pH ranging from 4.5 to 5.5.

13. The process according to claim 1, wherein the material also contains modified starch, products for the reduction of the filtrate and soluble salts.

14. The process according to claim 13, wherein the starch is selected from Dualflo, N-Drill HT, Flotrol.

15. The process according to claim 13, wherein the products for the reduction of the filtrate are calcium carbonate or bentonite which are present in concentrations of up to 15% by weight.

16. The process according to claim 13, wherein the soluble salt is KCl which is present in a concentration ranging from 1 to 5% by weight.

17. (canceled)

18. A method of degrading a scleroglucan and/or xanthan gum material, comprising:
treating said scleroglucan and/or xanthan gum material with a cellulase from Trichoderma reesei and/or a glucosidase from Aspergillus Niger.
